(19) United States
(12) Patent Application Publication
(10) Pub. No.: US 2024/0278781 A1
(43) Pub. Date: Aug. 22, 2024

(54) VEHICLE AND CONTROL DEVICE

(71) Applicant: PANASONIC AUTOMOTIVE SYSTEMS CO., LTD., Kanagawa (JP)

(72) Inventor: Jinsong DUAN, Tokyo (JP)

(73) Assignee: PANASONIC AUTOMOTIVE SYSTEMS CO., LTD., Kanagawa (JP)

(21) Appl. No.: 18/653,545

(22) Filed: May 2, 2024

Related U.S. Application Data
(63) Continuation of application No. PCT/JP2022/037058, filed on Oct. 4, 2022.

(30) Foreign Application Priority Data
Nov. 5, 2021 (JP) 2021-181255

(51) Int. Cl. B60W 30/18; B60W 50/14; G06V 20/56; G06V 20/58; H04W 4/44

(52) U.S. Cl. CPC B60W 30/181; B60W 50/14; G06V 20/584; G06V 20/588; H04W 4/44; B60W 2420/403; B60W 2520/10; B60W 2552/53; B60W 2555/60; B60W 2556/45

(57) ABSTRACT

A vehicle includes a first wheel, a second wheel, the vehicle being movable in a predetermined direction using the first wheel and the second wheel, an imaging device, and a wireless communication circuit set to receive traffic light information which is information related to a traffic light. When the received traffic light information indicates a stop command, a stop position is detected based on a captured image by the imaging device, and the vehicle stops at the stop position.

### CROSS-REFERENCE TO RELATED APPLICATIONS

The present application is a continuation application of PCT/JP2022/037058 that claims priority to Japanese Patent Application No. 2021-181255 filed on Nov. 5, 2021, the entire content of which is incorporated herein by reference.

### TECHNICAL FIELD

The present disclosure relates to a vehicle and a control device.

### BACKGROUND ART

Patent Literature 1 discloses an autonomous traveling control device that includes a navigation system and a front camera that detect the position of a vehicle and the position of an intersection, an accident information reception unit that acquires past accident information at the intersection from an accident information server, and a target vehicle speed and target lateral position calculation unit that sets a target vehicle speed when traveling at the intersection based on the past accident information at the intersection, and controls traveling speed of the vehicle to the set target vehicle speed.

### CITATION LIST

### Patent Literature

Patent Literature 1: JP2019-008411A

Patent Literature 2: WO2017/212821

### SUMMARY OF INVENTION

### Technical Problem

However, a study for enabling the vehicle entering the intersection to stop and start appropriately and safely in accordance with an instruction from a traffic light installed at the intersection is insufficient.

An object of the present disclosure is to provide a technique for appropriately and safely stopping and starting a vehicle entering an intersection in accordance with an instruction from a traffic light installed at the intersection.

### Solution to Problem

A vehicle according to the present disclosure includes: a first wheel; a second wheel, the vehicle being movable in a predetermined direction using the first wheel and the second wheel; an imaging device; and a wireless communication circuit set to receive traffic light information which is information related to a traffic light, in which when the received traffic light information indicates a stop command, a stop position is detected based on a captured image by the imaging device, and the vehicle stops at the stop position.

A control device according to the present disclosure to be mounted on a vehicle, the vehicle including a first wheel and a second wheel, being movable in a predetermined direction using the first wheel and the second wheel, and including an imaging device and a wireless communication circuit set to receive traffic light information which is information related to a traffic light, in which when the traffic light information received by the wireless communication circuit indicates a stop command, the control device detects a stop position based on a captured image by the imaging device and causes the vehicle to stop at the stop position.

These comprehensive or specific aspects may be implemented by a system, a device, a method, an integrated circuit, a computer program, or a recording medium, or any combination of the system, the device, the method, the integrated circuit, the computer program, and the recording medium.

### Advantageous Effects of Invention

According to the present disclosure, it is possible to appropriately and safely stop and start a vehicle entering an intersection in accordance with an instruction from a traffic light installed at the intersection.

### BRIEF DESCRIPTION OF DRAWINGS

FIG. 1 is a schematic diagram illustrating an example of a configuration of a vehicle according to Embodiment 1;

FIG. 2 is a block diagram illustrating an example of a configuration of devices provided in the vehicle according to Embodiment 1;

FIG. 3 is a diagram illustrating an example of traffic light information according to Embodiment 1;

FIG. 4 is a flowchart illustrating an operation example of the vehicle according to Embodiment 1;

FIG. 5 is a diagram illustrating an example of a captured image of an area in front of the vehicle according to Embodiment 1;

FIG. 6 is an overhead view of an intersection at which a traffic light in a traveling direction of the vehicle according to Embodiment 1 is turned on in red;

FIG. 7 is an overhead view of the intersection at which the traffic light in the traveling direction of the vehicle according to Embodiment 1 is turned on in blue;

FIG. 8 is an overhead view of the intersection at which the traffic light in the traveling direction of the vehicle according to Embodiment 1 is turned on in yellow;

FIG. 9 is a flowchart illustrating details of red signal processing in FIG. 4;

FIG. 10 is a diagram illustrating an example of an HMI device that displays a red signal stop image according to Embodiment 1;

FIG. 11 is a diagram illustrating an example of the HMI device that displays a switching image from a red signal to a blue signal according to Embodiment 1;

FIG. 12 is a flowchart illustrating details of blue signal processing illustrated in FIG. 4;

FIG. 13 is a diagram illustrating an example of the HMI device that displays a blue signal straight-ahead image according to Embodiment 1;

FIG. 14 is a diagram illustrating an example of the HMI device that displays a blue signal left turn image according to Embodiment 1;

FIG. 15 is a diagram illustrating an example of the HMI device that displays a blue signal right turn image according to Embodiment 1; and

FIG. 16 is a flowchart illustrating details of yellow signal processing in FIG. 4.

### DESCRIPTION OF EMBODIMENTS

Hereinafter, an embodiment of the present disclosure will be described in detail with reference to the drawings as appropriate. However, more detailed description may be omitted. For example, detailed description of already well-known matters and redundant description of substantially the same configuration may be omitted. This is to avoid unnecessary redundancy of the following description and to facilitate understanding of a person skilled in the art. It should be noted that the accompanying drawings and the following description are provided for the person skilled in the art to sufficiently understand the present disclosure, and are not intended to limit the subject matter described in claims.

### (Embodiment 1)

### <Configuration of Vehicle>

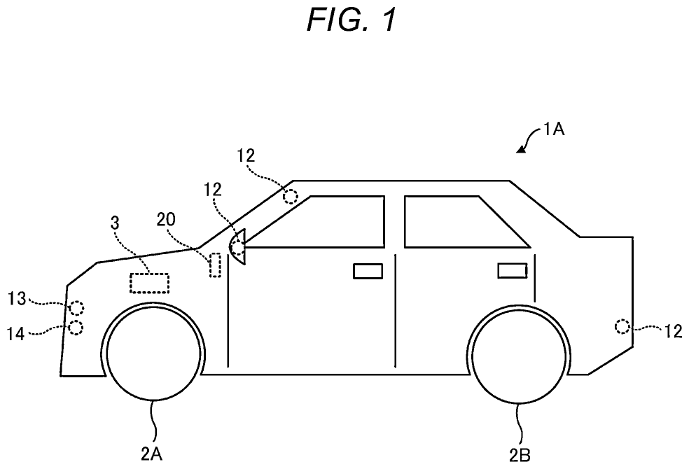

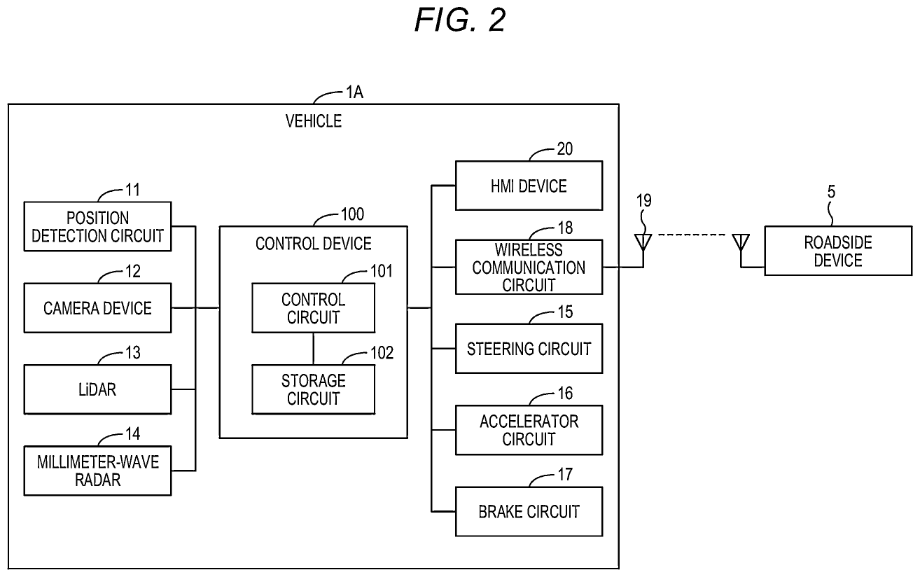

FIG. 1 is a schematic diagram illustrating an example of a configuration of a vehicle 1A according to Embodiment 1. FIG. 2 is a block diagram illustrating an example of a configuration of devices provided in the vehicle 1A according to Embodiment 1.

The vehicle 1A includes a drive unit 3 such as an engine or a motor, and at least first wheels 2A and second wheels 2B. The vehicle 1A can travel by the drive unit 3 rotationally driving at least one of the first wheels 2A and the second wheels 2B. When the vehicle 1A includes four wheels, the first wheels 2A may be front wheels, and the second wheels 2B may be rear wheels. However, the vehicle 1A is not limited to the case of including the four wheels, and may include one to three wheels or five or more wheels.

The vehicle 1A may include advanced driver-assistance systems (ADAS). The vehicle 1A may have an autonomous driving function. An autonomous driving level of the autonomous driving function of the vehicle 1A may be any one of level 0 to level 5. Alternatively, the vehicle 1A may include both the ADAS and the autonomous driving function, or may not include both the ADAS and the autonomous driving function.

The vehicle 1A includes a position detection circuit 11, camera devices 12, a laser imaging detection and ranging (LiDAR) 13, a millimeter-wave radar 14, a steering circuit 15, an accelerator circuit 16, a brake circuit 17, a wireless communication circuit 18, a control device 100, and a human machine interface (HMI) device 20. These devices 11 to 18, 20, and 100 may be configured as one or a plurality of electronic control units (ECUs). Further, these devices 11 to 18, 20, and 100 may transmit and receive information to and from one another through a communication network (not illustrated) provided in the vehicle 1A. Examples of the communication network provided in the vehicle 1A include a controller area network (CAN), LIN, and FlexRay.

The position detection circuit 11 can acquire position information of the vehicle 1A. For example, the position detection circuit 11 measures a position of the vehicle 1A using a global navigation satellite system (GNSS), and acquires the position information indicating the measured position of the vehicle 1A. The position information may include a measured time point and longitude, latitude, and altitude measured at the time point.

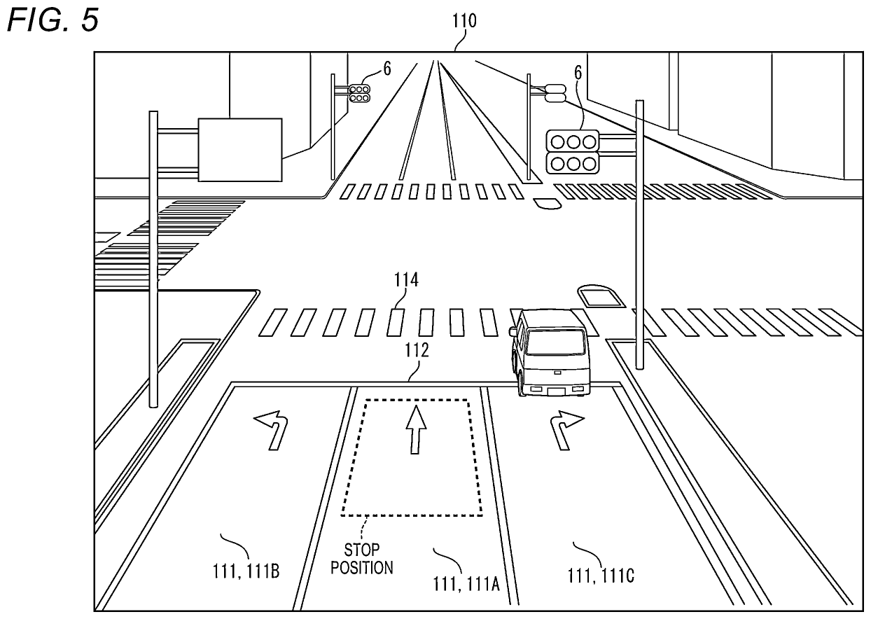

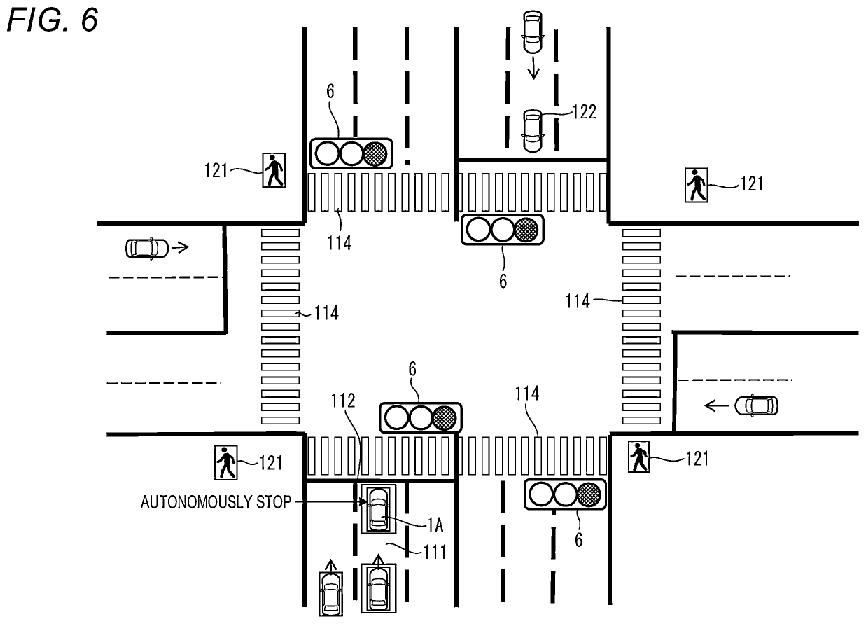

The camera device 12 captures an image of surroundings of the vehicle 1A and generates a surrounding image. The surrounding image may be either a still image or a moving image. As illustrated in FIG. 1, the vehicle 1A may include a plurality of camera devices 12, and may generate a surrounding image by deforming and synthesizing images captured by the camera devices 12. Alternatively, the vehicle 1A may include a camera device 12 capable of capturing an omnidirectional image, and may generate a surrounding image by deforming the image captured by the camera device 12. The surrounding image generated by the camera device 12 may be used for detecting objects present around the vehicle 1A. Examples of the objects (obstacles) present around the vehicle 1A include other vehicles, pedestrians 121 (see FIGS. 6 to 8), bicycles, installed objects, and road signs installed on a road. Further, the surrounding image may be used for detecting a traffic sign on a road surface of a road on which the vehicle 1A is traveling. Examples of the traffic sign include a lane defining a traveling lane 111 (see FIGS. 5 to 8), a stop line 112 (see FIGS. 5 to 8) defining a stop position, a crosswalk 114 (see FIGS. 5 to 8), and an arrow indicating a traveling direction. The stop position is not limited to the stop line 112 on the road surface, and may be defined by, for example, a signboard of a road sign installed on the road.

The LiDAR 13 is a device that detects the objects present around the vehicle 1A by irradiating the surroundings of the vehicle 1A with laser light and measuring reflected light thereof.

The millimeter-wave radar 14 is a device that detects the objects present around the vehicle 1A by irradiating the surroundings of the vehicle 1A with millimeter waves and measuring reflected waves thereof.

The vehicle 1A may detect the objects present around the vehicle 1A by using the camera devices 12, the LiDAR 13, and the millimeter-wave radar 14 in a complementary manner. Alternatively, the vehicle 1A may include at least one of the camera devices 12, the LiDAR 13, and the millimeter-wave radar 14, and may detect the objects present around the vehicle 1A using information obtained from at least one of the camera devices 12, the LiDAR 13, and the millimeter-wave radar 14. As described above, since the camera devices 12, the LiDAR 13, and the millimeter-wave radar 14 are examples of devices used for detecting the objects, these devices may be replaced with object detection devices.

The steering circuit 15 is a circuit capable of steering at least one of the first wheels 2A and the second wheels 2B provided in the vehicle 1A. For example, the steering circuit 15 controls steering of the first wheels 2A (front wheels) to control a direction in which the vehicle 1A makes a turn (for example, a right turn or a left turn).

The accelerator circuit 16 is a circuit that controls an accelerator to control acceleration and deceleration of the vehicle 1A. When the vehicle 1A is steered by a driver, the accelerator circuit 16 may control the acceleration and deceleration of the vehicle 1A in accordance with an accelerator operation performed by the driver. When the vehicle 1A is steered by the ADAS or the autonomous driving function, the accelerator circuit 16 may control the acceleration and deceleration of the vehicle 1A in accordance with an instruction from the control device 100.

The brake circuit 17 is a circuit that controls the deceleration and stopping of the vehicle 1A by controlling a brake. When the vehicle 1A is steered by the driver, the brake circuit 17 may control the deceleration and stopping of the vehicle 1A in accordance with a brake operation performed by the driver. When the vehicle 1A is steered by the ADAS or the autonomous driving function, the brake circuit 17 may control the deceleration and stopping of the vehicle 1A in accordance with an instruction from the control device 100.

The wireless communication circuit 18 is a circuit capable of wirelessly communicating with a roadside device 5 installed on the road through an antenna 19. The wireless communication circuit 18 may be a circuit capable of performing V2X communication. For example, the wireless communication circuit 18 receives information transmitted from the roadside device 5 through the antenna 19 by the V2X communication. The V2X communication may be any of vehicle to vehicle (V2V) communication, vehicle to pedestrian (V2P) communication, vehicle to infrastructure (V2I) communication, and vehicle to network (V2N) communication. Examples of a V2X communication scheme include dedicated short range communications (DSRC) and cellular-V2x (C-V2X). The V2X communication scheme may correspond to 4G or 5G.

The control device 100 is a device that controls a behavior of the vehicle 1A. The control device 100 mounted on the vehicle 1A is not limited to one control device, and a plurality of control devices 100 may be provided. The control device 100 may include a control circuit 101. The control circuit 101 may be replaced with other terms such as a central processing unit (CPU), a processor, a controller, and an arithmetic circuit. A storage circuit 102 may be connected to the control circuit 101. The storage circuit 102 may be configured as a read-only memory (ROM), a random access memory (RAM), a flash memory, or a combination thereof. The control circuit 101 may implement functions of the vehicle 1A and the control device 100 according to Embodiment 1 by reading and executing data and a computer program recorded in the storage circuit 102. The functions of the vehicle 1A and the control device 100 according to Embodiment 1 are not limited to being implemented by one control circuit 101, and may be implemented by cooperation of the plurality of control circuits 101.

The control circuit 101 may achieve driving assistance or autonomous driving of the vehicle 1A based on the information received from at least one of the position detection circuit 11, the camera device 12, the LiDAR 13, and the millimeter-wave radar 14.

The control circuit 101 controls a steering direction, a traveling speed, a start, a stop, and the like of the vehicle 1A through the steering circuit 15, the accelerator circuit 16, and the brake circuit 17, and causes the vehicle 1A to travel according to scheduled route information set in advance through, for example, a navigation system (not illustrated). That is, the scheduled route information indicates a route for the vehicle 1A to reach a destination from a preset departure point. The scheduled route information may include at least one piece of position information indicating current and future positions of the vehicle 1A and at least one piece of direction information indicating current and future directions of the vehicle 1A. The navigation system may be car navigation mounted on the vehicle 1A or may be a smartphone carried by the driver.

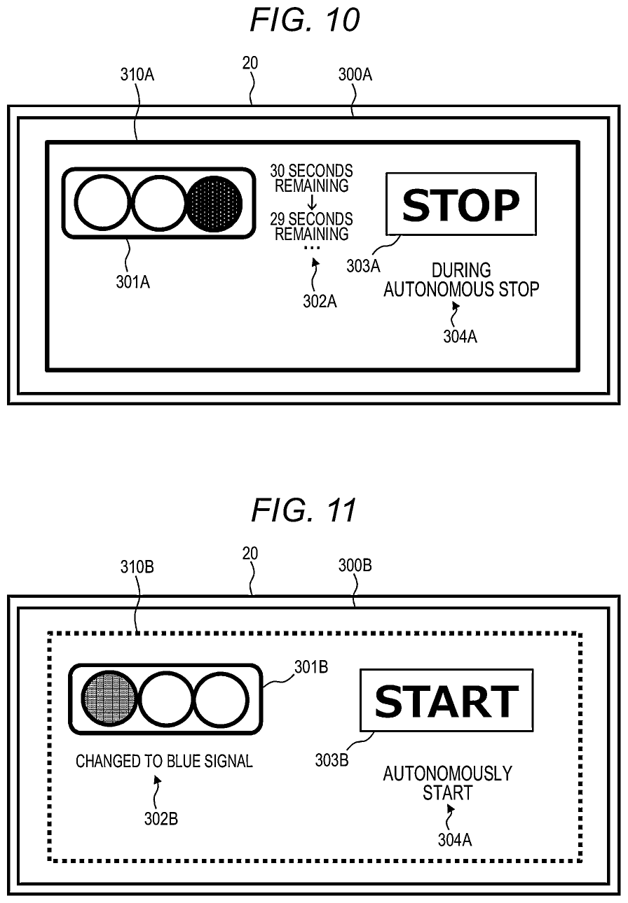

The HMI device 20 is a device that provides information related to ADAS and/or the autonomous driving, and the like to the driver or an occupant of the vehicle 1A. The HMI device 20 may include a display device (for example, a head-up display (HUD)). For example, the HMI device 20 may display, on the display device, information (image) related to a traffic light 6 (see FIGS. 5 to 8) at the intersection that the vehicle 1A enters next. Details of the image displayed on the HMI device 20 will be described later (see FIGS. 10, 11, 13, 14, and 15).

### <Configuration of Traffic Light Information>

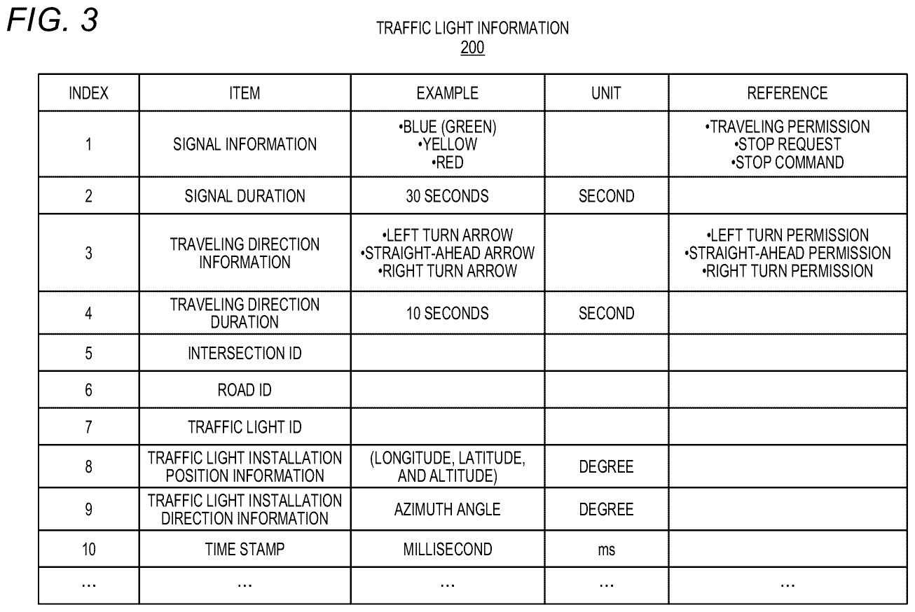

FIG. 3 is a diagram illustrating an example of traffic light information 200 according to Embodiment 1.

The roadside device 5 is installed, for example, at an intersection including the traffic light 6. The roadside device 5 repeatedly broadcasts the traffic light information 200 including the information related to the traffic light 6 (see FIGS. 5 to 8) by the wireless signal related to the V2X communication. The roadside device 5 may be integrated with or separate from the traffic light 6.

As illustrated in FIG. 3, the traffic light information 200 includes signal information, signal duration, traveling direction information, traveling direction duration, intersection ID, road ID, traffic light ID, traffic light installation position information, traffic light installation direction information, and time stamp.

The signal information indicates which of a stop command, traveling permission, and a stop request is being presented to the vehicle 1A by the traffic light 6 corresponding to the traffic light information 200. Information indicating the stop command corresponds to red lighting (red signal) of the traffic light 6, information indicating the traveling permission corresponds to blue lighting (blue signal) or green lighting (green signal) of the traffic light 6, and information indicating the stop request corresponds to yellow lighting (yellow signal) of the traffic light 6. The lighting color of the traffic light 6 in the present embodiment is an example in Japan, and may be replaced with lighting color of the traffic light 6 according to the traffic regulation of a foreign country in the foreign country.

The signal duration indicates a remaining time during which the presentation of the signal information continues. For example, when the signal information indicates a stop command (red lighting) and the signal duration indicates “30 seconds”, the red lighting continues for 30 seconds.

The traveling direction information indicates which of left turn permission, straight-ahead permission, and right turn permission is being presented to the vehicle 1A by the traffic light 6 corresponding to the traffic light information 200. Information indicating the left turn permission corresponds to left turn arrow lighting (left turn arrow signal) of the traffic light 6, information indicating the straight-ahead permission corresponds to straight-ahead arrow lighting (straight-ahead arrow signal) of the traffic light 6, and information indicating the right turn permission corresponds to right turn arrow lighting (right turn arrow signal) of the traffic light 6. The arrow indicating the traveling direction of the traffic light 6 in the present embodiment is an example in Japan, and may be replaced as a symbol of the traffic light 6 according to the traffic regulation of a foreign country in the foreign country.

The traveling direction duration indicates a remaining time during which the presentation of the traveling direction information continues. For example, when the traveling direction information indicates the right turn permission (right turn arrow lighting) and the traveling direction duration indicates “10 seconds”, it indicates that the right turn arrow lighting continues for 10 seconds.

The intersection ID is information for identifying the intersection at which the traffic light 6 corresponding to the traffic light information 200 is installed.

The road ID is information for identifying the road on which the traffic light 6 corresponding to the traffic light information 200 is installed.

The traffic light ID is information for identifying the traffic light 6 corresponding to the traffic light information 200.

The traffic light installation position information indicates a position where the traffic light 6 corresponding to the traffic light information 200 is installed. The traffic light installation position information may indicate the position where the traffic light 6 is installed by longitude, latitude, and altitude.

The traffic light installation direction information indicates a direction that the traffic light 6 corresponding to the traffic light information 200 faces. The traffic light installation direction information may indicate the direction that the traffic light 6 faces by an azimuth angle.

The time stamp indicates a transmission time point of the traffic light information 200. The transmission time point is not limited to a mere time point and may include year, month, and day.

### <Overall Flow>

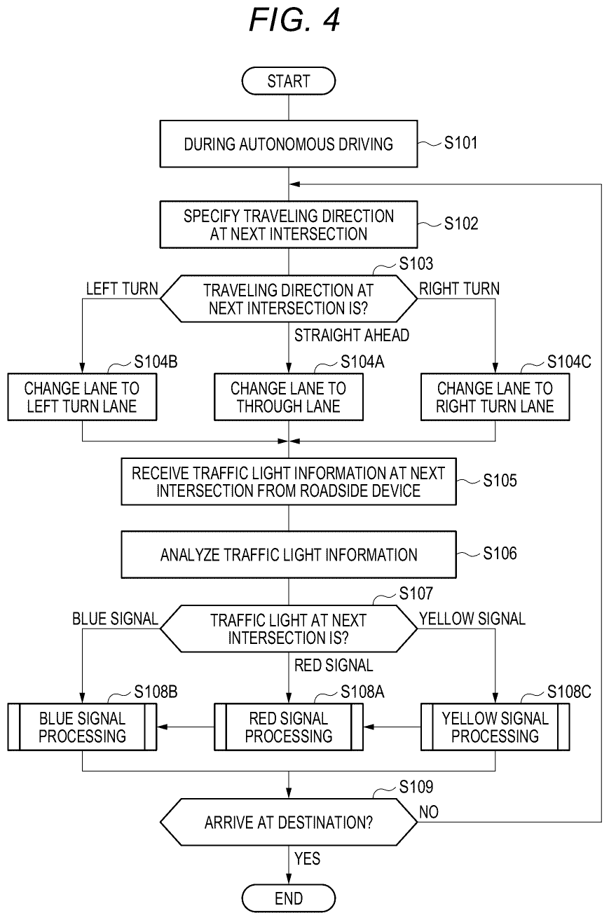

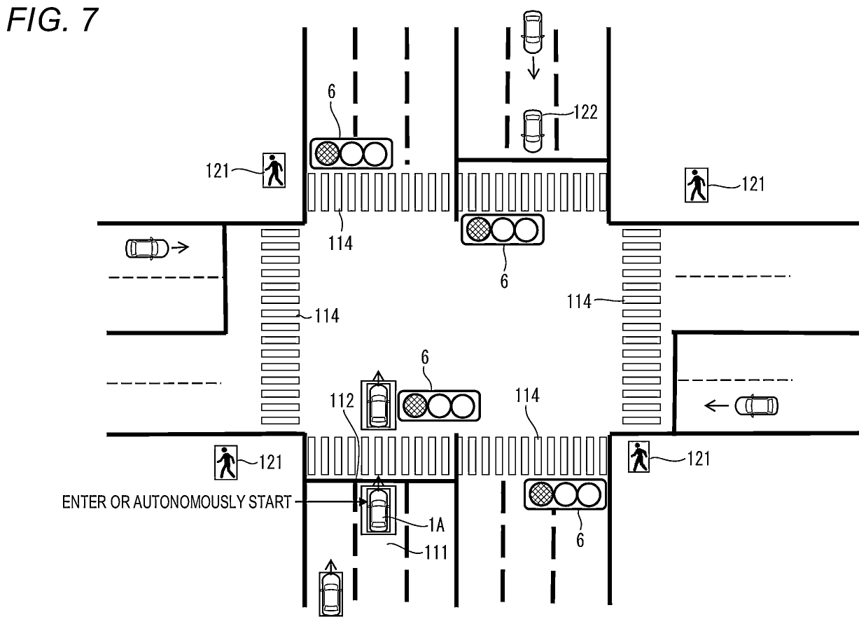

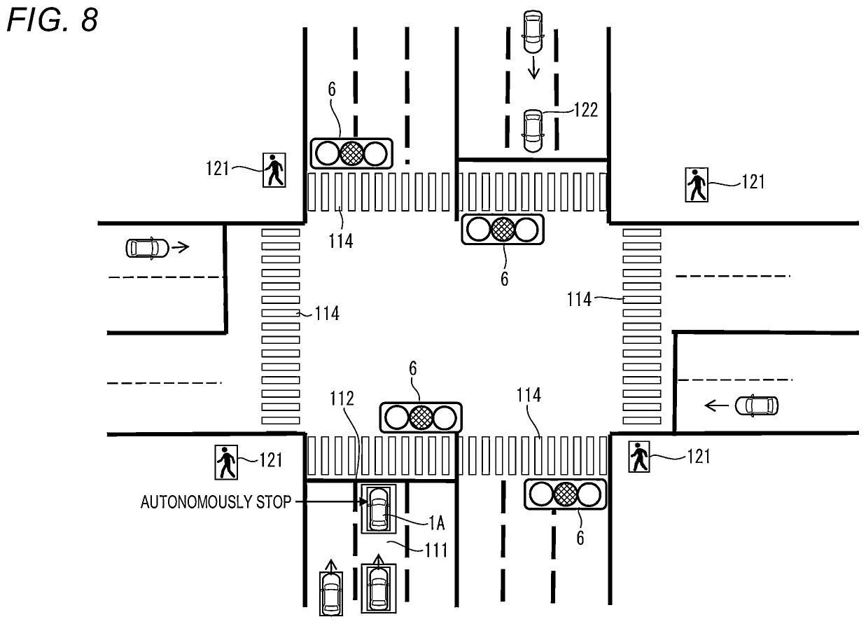

FIG. 4 is a flowchart illustrating an operation example of the vehicle 1A according to Embodiment 1. FIG. 5 is a diagram illustrating an example of an image (hereinafter, referred to as a front image 110) obtained by imaging an area in front of the vehicle 1A according to Embodiment 1. The front image 110 may be a part of the above-described surrounding image. FIG. 6 is an overhead view of an intersection at which the traffic light 6 in the traveling direction of the vehicle 1A according to Embodiment 1 is turned on in red. FIG. 7 is an overhead view of the intersection at which the traffic light 6 in the traveling direction of the vehicle 1A according to Embodiment 1 is turned on in blue. FIG. 8 is an overhead view of the intersection at which the traffic light 6 in the traveling direction of the vehicle 1A according to Embodiment 1 is turned on in yellow. Next, an operation example of the vehicle 1A in a case where the vehicle 1A during the autonomous driving according to Embodiment 1 enters the intersection including the traffic light 6 will be described with reference to FIGS. 4 to 8.

The vehicle 1A sets the scheduled route information for reaching the destination from the departure point, and performs autonomous driving according to the route indicated by the scheduled route information (S101). The driver may input the destination to the navigation system (not illustrated), and the navigation system may calculate a route from the departure point to the destination and set the scheduled route information. The departure point may be the current position of the vehicle 1A when the driver inputs the destination, or may be a position input by the driver.

The vehicle 1A specifies a next intersection when traveling along the route indicated by the scheduled route information from the current position and the traveling direction indicated by the route at the next intersection (S102).

The vehicle 1A determines whether the traveling direction of the next intersection specified in step S102 is straight ahead, a left turn, or a right turn (S103).

When the traveling direction of the next intersection is the “straight ahead” (S103: straight ahead), the vehicle 1A changes the lane to a through lane 111A as necessary (S104A). The vehicle 1A then causes the processing to proceed to step S105.

When the traveling direction of the next intersection is the “left turn” (S103: left turn), the vehicle 1A changes the lane to the left turn lane 111B as necessary (S104B). The vehicle 1A then causes the processing to proceed to step S105.

When the traveling direction of the next intersection is “right turn” (S103: right turn), the vehicle 1A changes the lane to a right turn lane 111C as necessary (S104C). The vehicle 1A then causes the processing to proceed to step S105.

The vehicle 1A receives the traffic light information 200 related to the traffic light 6 at the next intersection which is repeatedly (for example, periodically) broadcasted by the roadside device 5 installed at the next intersection (S105).

The vehicle 1A analyzes the content of the traffic light information 200 received in step S105 (S106).

As a result of the analysis of the traffic light information 200 in step S106, the vehicle 1A determines whether the traffic light 6 at the next intersection is the red signal, the blue signal, or the yellow signal (S107). For example, when the signal information provided in the traffic light information 200 indicates the “stop command”, the vehicle 1A determines that the traffic light 6 is the “red signal”. When the signal information provided in the traffic light information 200 indicates the “traveling permission”, the vehicle 1A determines that the traffic light 6 is the “blue signal”. When the signal information provided in the traffic light information 200 indicates the “stop request”, the vehicle 1A determines that the traffic light 6 is the “yellow signal”.

When the traveling direction of the route at the next intersection is the “straight ahead” and the traveling direction information provided in the traffic light information 200 indicates the “straight-ahead permission”, the vehicle 1A may set the determination result of step S107 to the “blue signal”, and when the traveling direction information indicates the “left turn permission” or the “right turn permission”, the vehicle 1A may set the determination result of step S107 to the “red signal”. When the traveling direction of the route at the next intersection is the “left turn” and the traveling direction information provided in the traffic light information 200 indicates the “left turn permission”, the vehicle 1A may set the determination result of step S107 to the “blue signal”, and when the traveling direction information indicates the “straight-ahead permission” or the “right turn permission”, the vehicle 1A may set the determination result of step S107 to the “red signal”. When the traveling direction of the route at the next intersection is the “right turn” and the traveling direction information provided in the traffic light information 200 indicates the “right turn permission”, the vehicle 1A may set the determination result of step S107 to the “blue signal”, and when the traveling direction information indicates the “left turn permission” or the “straight-ahead permission”, the vehicle 1A may set the determination result of step S107 to the “red signal”.

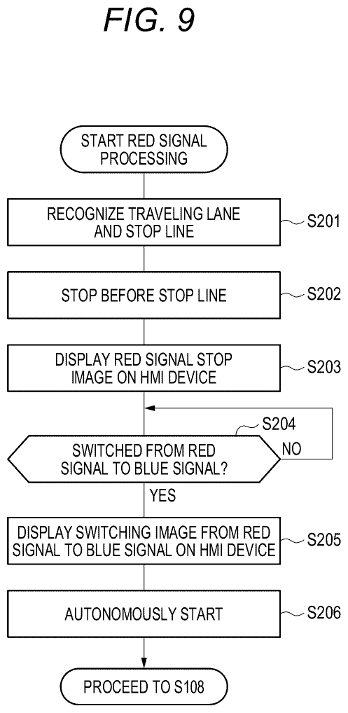

When the traffic light 6 at the next intersection is the “red signal” (S107: red signal), the vehicle 1A performs red signal processing (S108A). The red signal processing will be described later in detail with reference to FIG. 9, but in this case, as illustrated in FIG. 6, the vehicle 1A autonomously stops at a stop position before the stop line 112. The vehicle 1A then causes the processing to proceed to step S108B.

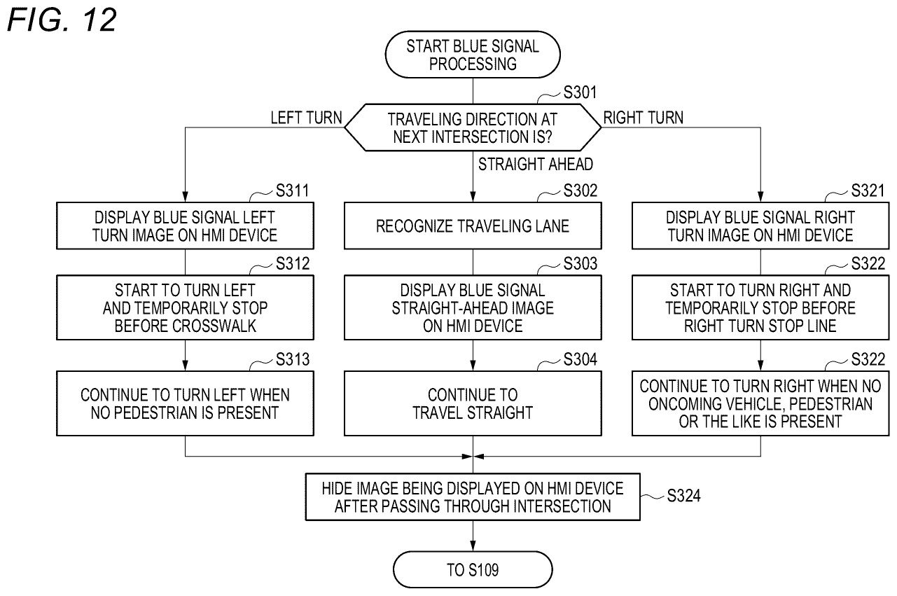

When the traffic light 6 at the next intersection is the “blue signal” (S107: blue signal), the vehicle 1A performs blue signal processing (S108B). The blue signal processing will be described in detail with reference to FIG. 12, but in this case, as illustrated in FIG. 7, the vehicle 1A may enter the intersection. The vehicle 1A then causes the processing to proceed to step S109.

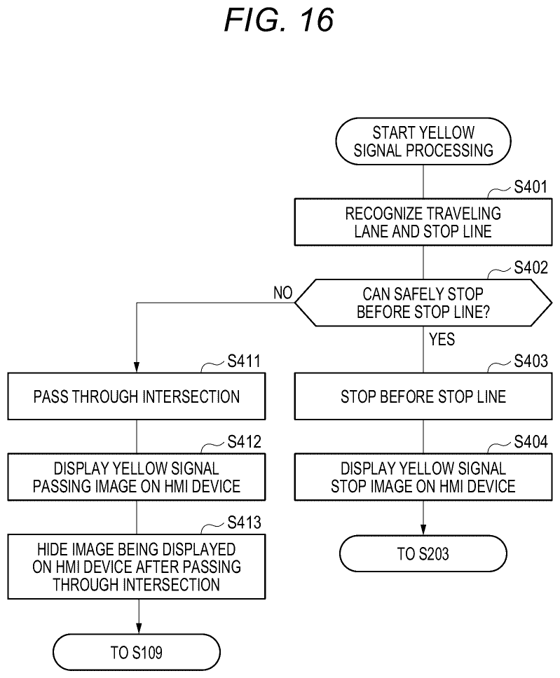

When the traffic light 6 at the next intersection is the “yellow signal” (S107: yellow signal), the vehicle 1A executes yellow signal processing (S108C). The yellow signal processing will be described in detail with reference to FIG. 16, but in this case, as illustrated in FIG. 8, the vehicle 1A autonomously stops at the stop position before the stop line 112 when the vehicle 1A can safely stop. The vehicle 1A then causes the processing to proceed to step S109.

The vehicle 1A determines whether the vehicle 1A has arrived at the destination (S109). When the vehicle 1A has arrived at the destination (S109: YES), the vehicle 1A stops and ends the present processing. When the vehicle 1A has not arrived at the destination (S109: NO), the vehicle 1A causes the processing to return to step S102.

### <Red Signal Processing>

FIG. 9 is a flowchart illustrating details of the red signal processing (S108A) illustrated in FIG. 4. FIG. 10 is a diagram illustrating an example of the HMI device 20 that displays a red signal stop image according to Embodiment 1. FIG. 11 is a diagram illustrating an example of the HMI device 20 that displays a switching image from the red signal to the blue signal according to Embodiment 1. Next, with reference to FIGS. 9 to 11, an operation example of the vehicle 1A in a case where the traffic light 6 at the intersection that the vehicle 1A enters during the autonomous driving according to Embodiment 1 is the red signal will be described.

The vehicle 1A detects the traveling lane 111 and the stop line 112 of the traveling lane 111 based on the front image 110 captured by the camera device 12 capable of imaging the front (S201).

The vehicle 1A decelerates to stop before the stop line 112 in the traveling lane 111 detected in step S201, and autonomously stops at the stop position before the stop line 112 (S202).

The vehicle 1A displays a red signal stop image 300A on the HMI device 20 (S203). As illustrated in FIG. 10, the red signal stop image 300A may include an icon 301A indicating the red signal, duration 302A until the red signal is switched to the blue signal, an icon 303A indicating a stop to the driver, a message 304A indicating that the vehicle 1A is autonomously stopped, and a frame line 310A surrounding the icons 301A, 303A, the duration 302A, and the message 304A. The color of the frame line 310A may be displayed in red corresponding to the red signal. The duration 302A until the red signal is switched to the blue signal corresponds to the signal duration provided in the traffic light information 200. Accordingly, the driver can recognize that the vehicle 1A autonomously stops by the red lighting of the traffic light 6 by viewing the display of the HMI device 20.

The vehicle 1A determines whether the traffic light 6 has switched from the red signal to the blue signal based on the traffic light information 200 received from the roadside device 5 (S204). Specifically, the vehicle 1A determines whether the signal information provided in the traffic light information 200 is switched from the “stop command” to the “traveling permission”.

When the signal is still the red signal (S204: NO), the vehicle 1A repeats the determination processing of step S204.

When the red signal is switched to the blue signal (S204: YES), the vehicle 1A causes the processing to step S205.

The vehicle 1A displays a switching image 300B from the red signal to the blue signal on the HMI device 20 for a predetermined time (for example, 3 seconds) (S205) and autonomously starts (S206). Accordingly, the vehicle 1A can autonomously start at the timing when the traffic light 6 is switched from the red signal to the blue signal.

As illustrated in FIG. 11, the switching image 300B from the red signal to the blue signal may include an icon 301B indicating the blue signal, a message 302B indicating that the red signal is switched to the blue signal, an icon 303B indicating the start to the driver, a message 304B indicating that the vehicle 1A autonomously starts, and a frame line 310B surrounding the icons 301B, 303B and the messages 302B, 304B. The color of the frame line 310B may be displayed in blue corresponding to the blue signal. Accordingly, the driver can recognize that the traffic light 6 is switched from the red lighting to the blue lighting and the vehicle 1A autonomously starts by viewing the display of the HMI device 20.

Then, the vehicle 1A causes the processing to proceed to step S108B (that is, the blue signal processing) illustrated in FIG. 4.

### <Blue Signal Processing>

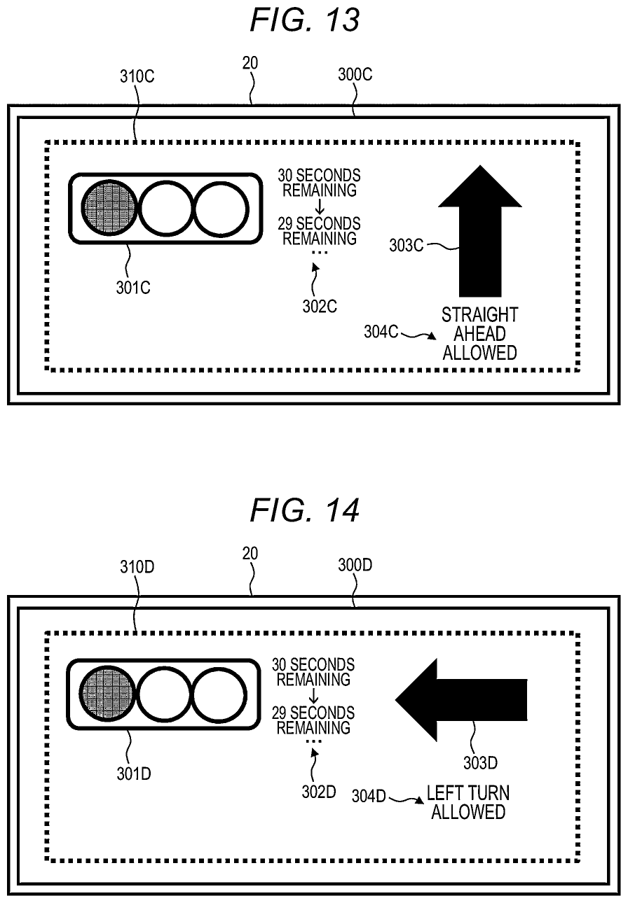

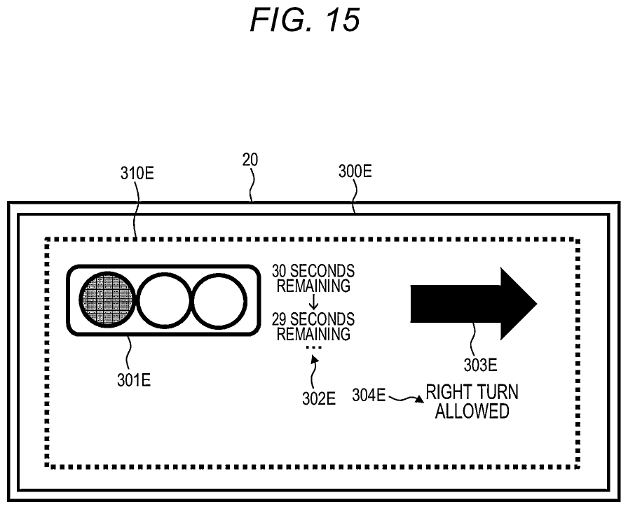

FIG. 12 is a flowchart illustrating details of the blue signal processing (S108B) illustrated in FIG. 4. FIG. 13 is a diagram illustrating an example of the HMI device 20 that displays a blue signal straight-ahead image 300C according to Embodiment 1. FIG. 14 is a diagram illustrating an example of the HMI device 20 that displays a blue signal left turn image 300D according to Embodiment 1. FIG. 15 is a diagram illustrating an example of the HMI device 20 that displays a blue signal right turn image 300E according to Embodiment 1.

Next, an operation example of vehicle 1A in a case where the traffic light 6 at the intersection that the vehicle 1A enters during the autonomous driving according to Embodiment 1 is the blue signal will be described with reference to FIGS. 12 to 15.

The vehicle 1A determines whether the traveling direction at the next intersection indicated by the route is straight ahead, a left turn, or a right turn (S301). The determination result may be the same as that in step S103.

First, a case where the traveling direction of the route at the next intersection is the “straight ahead” (S301: straight ahead) will be described.

The vehicle 1A recognizes the traveling lane 111 based on the front image 110 obtained by the camera device 12 capable of imaging the front (S302).

The vehicle 1A displays the blue signal straight-ahead image 300C on the HMI device 20 (S303). As illustrated in FIG. 13, the blue signal straight-ahead image 300C may include an icon 301C indicating a blue signal, duration 302C until the blue signal is switched to a yellow signal, an icon 303C indicating straight ahead to the driver, a message 304C indicating that the straight ahead is possible, and a frame line 310C surrounding the icons 301C, 303C, the duration 302C, and the message 304C. The color of the frame line 310C may be displayed in blue corresponding to the blue signal. The duration until the blue signal is switched to the yellow signal corresponds to the signal duration provided in the traffic light information 200. Accordingly, the driver can recognize that the vehicle 1A enters the intersection and travels straight since the traffic light 6 is turned on in blue by viewing the display of the HMI device 20. When the vehicle 1A executes the processing illustrated in FIG. 12 because the traveling direction information provided in the traffic light information 200 is the “straight-ahead permission” as a result of the analysis in step S106, the duration 302C until the blue signal is switched to the yellow signal illustrated in FIG. 13 corresponds to the traveling direction duration provided in the traffic light information 200.

The vehicle 1A continues to travel straight and enters the intersection (S304). The vehicle 1A then causes the processing to proceed to step S324.

Next, a case where the traveling direction of the route at the next intersection is the “left turn” (S301: left turn) will be described.

The vehicle displays the blue signal left turn image 300D on the HMI device 20 (S311). As illustrated in FIG. 14, the blue signal left turn image 300D may include an icon 301D indicating a blue signal, duration 302D until the blue signal is switched to a yellow signal, an icon 303D indicating a left turn to the driver, a message 304D indicating that the left turn is possible, and a frame line 310D surrounding the icons 301D, 303D, the duration 302D, and the message 304D. The color of the frame line 310D may be displayed in blue corresponding to the blue signal. Accordingly, the driver can recognize that the vehicle 1A enters the intersection and turns left since the traffic light 6 is turned on in blue by viewing the display of the HMI device 20. When the vehicle 1A executes the processing illustrated in FIG. 12 because the traveling direction information provided in the traffic light information 200 is the “left turn permission” as a result of the analysis in step S106, the duration 302D until the blue signal is switched to the yellow signal illustrated in FIG. 14 corresponds to the traveling direction duration provided in the traffic light information 200.

The vehicle 1A starts to turn left while traveling slowly, and temporarily stops before the crosswalk 114 (S312).

The vehicle 1A determines whether the pedestrian 121 (see FIG. 6) or the bicycle, or the like is present on or around the crosswalk 114, and continues and completes the left turn when no pedestrian 121 or the bicycle or the like is present (S313). The vehicle 1A may determine whether the pedestrian 121 or the bicycle, or the like is present on or around the crosswalk 114 based on, for example, the surrounding image by the camera device 12 and/or the detection result by the LiDAR 13 and the millimeter-wave radar 14. Alternatively, the vehicle 1A may determine whether the pedestrian 121 or the bicycle, or the like is present on or around the crosswalk 114 based on the V2P communication. In a case where the pedestrian 121 or the bicycle, or the like is present on or around the crosswalk 114, the vehicle 1A continues to stop temporarily, and continues and completes the left turn after the pedestrian 121 or the bicycle, or the like is no longer present. The vehicle 1A then causes the processing to proceed to step S324.

Next, a case where the traveling direction of the route at the next intersection is the “right turn” (S301: right turn) will be described.

The vehicle 1A displays the blue signal right turn image 300E on the HMI device 20 (S321). As illustrated in FIG. 15, the blue signal right turn image 300E may include an icon 301E indicating the blue signal, duration 302E until the blue signal is switched to the yellow signal, an icon 303E indicating the right turn to the driver, a message 304E indicating that the right turn is possible, and a frame line 310E surrounding the icons 301E, 303E, the duration 302E, and the message 304E. The color of the frame line 310E may be displayed in blue corresponding to the blue signal. Accordingly, the driver can recognize that the vehicle 1A enters the intersection and turns right since the traffic light 6 is turned on in blue by viewing the display of the HMI device 20. When the vehicle 1A executes the processing illustrated in FIG. 12 because the traveling direction information provided in the traffic light information 200 is the “right turn permission” as a result of the analysis in step S106, the duration 302E until the blue signal is switched to the yellow signal illustrated in FIG. 15 corresponds to the traveling direction duration provided in the traffic light information 200.

The vehicle 1A starts to turn right while traveling slowly, and temporarily stops before a right-turn stop line (S322).

The vehicle 1A determines whether an oncoming vehicle 122 (see FIG. 6) entering the intersection is present, and whether the pedestrian 121 or the bicycle, or the like is present on or around the crosswalk 114, and continues and completes the right turn when the oncoming vehicle 122, the pedestrian 121 or the bicycle, or the like are not present (S323). When the oncoming vehicle 122, the pedestrian 121 or the bicycle, or the like are present, the vehicle 1A continues to stop temporarily, and continues and completes the right turn after the oncoming vehicle 122, the pedestrian 121 or the bicycle, or the like are no longer present. Then, the vehicle 1A causes the processing to proceed to S324.

After passing through the intersection, the vehicle 1A hides the image being displayed on the HMI device 20 (S324). The vehicle 1A then causes the processing to proceed to step S109 illustrated in FIG. 4.

### <Yellow Signal Processing>

FIG. 16 is a flowchart illustrating details of the yellow signal processing (S108C) illustrated in FIG. 4. Next, an operation example of vehicle 1A in a case where the traffic light 6 at the intersection that the vehicle 1A enters during the autonomous driving according to Embodiment 1 is the yellow signal will be described with reference to FIG. 16.

The vehicle 1A detects the traveling lane 111 and the stop line 112 of the traveling lane 111 based on the front image 110 captured by the camera device 12 capable of imaging the front (S 401).

The vehicle 1A determines whether the vehicle 1A can safely stop before the stop line 112 based on a current speed (S 402). For example, when the current speed is less than a predetermined threshold, the vehicle 1A determines that the vehicle 1A can safely stop before the stop line 112, and when the current speed is equal to or greater than the predetermined threshold, the vehicle 1A determines that the vehicle 1A cannot safely stop before the stop line 112. The vehicle 1A may perform the determination also in consideration of a distance from the current position to the stop line 112.

First, a case where the vehicle 1A can safely stop before the stop line 112 (S402: YES) will be described.

The vehicle 1A decelerates to stop before the stop line 112 detected in step S401, and autonomously stops at the stop position before the stop line 112 (S403). Accordingly, if the vehicle 1A can stop safely, the vehicle 1A can stop safely before the stop line 112.

The vehicle 1A displays a yellow signal stop image on the HMI device 20 (S404). Although the yellow signal stop image is not illustrated, the yellow signal stop image may be obtained by replacing the icon 301A indicating the red signal of the red signal stop image 300A illustrated in FIG. 10 with an icon indicating the yellow signal. The frame line in the yellow signal stop image may be displayed in yellow corresponding to the yellow signal.

Then, the vehicle 1A causes the processing to proceed to step S203 illustrated in FIG. 9, and displays the red signal stop image 300A on the HMI device 20.

Next, a case where the vehicle 1A cannot safely stop before the stop line 112 (S402: NO) will be described.

The vehicle 1A passes through the intersection (S411) and displays the yellow signal passing image on the HMI device 20 (S412). Although the yellow signal passing image is not illustrated, the yellow signal passing image may be similar to the yellow signal stop image. Accordingly, the vehicle 1A can pass through the intersection without stopping at a position beyond the stop line 112 (for example, in the intersection).

After passing through the intersection, the vehicle 1A hides the image being displayed on the HMI device 20 (S413). The vehicle 1A then causes the processing to proceed to step S109 illustrated in FIG. 4.

### <Modification>

Although a case where the vehicle travels on a left side has been described above, the present embodiment is also applicable to a case where the vehicle travels on a right side.

### (Summary of Present Disclosure)

The content of the present disclosure can be expressed as follows.

### <Expression 1>

The vehicle 1A includes: the first wheel 2A; the second wheel 2B, the vehicle 1A being movable in a predetermined direction using the first wheel 2A and the second wheel 2B; an imaging device (for example, the camera device 12); and the wireless communication circuit 18 set to receive traffic light information 200 which is information related to a traffic light 6, in which when the received traffic light information 200 indicates a stop command, a stop position (for example, a position before the stop line 112) is detected based on a captured image (for example, the front image 110) by the imaging device 12, and the vehicle 1A stops at the stop position.

Accordingly, when the received traffic light information 200 indicates the stop command, the vehicle 1A can safely stop at the stop position (for example, the position before the stop line 112) detected from the captured image.

### <Expression 2>

When the received traffic light information 200 indicates the stop command, the vehicle 1A according to Expression 1 may detect a traveling lane and the stop position based on the captured image by the imaging device, and stop at the stop position in the traveling lane.

Accordingly, when the received traffic light information 200 indicates the stop command, the vehicle 1A can safely stop at the stop position in the traveling lane detected from the captured image.

### <Expression 3>

In the vehicle 1A according to Expression 1 or 2, the stop command of the traffic light information 200 may correspond to red lighting of the traffic light 6.

Accordingly, when the traffic light 6 is turned on in red, the vehicle 1A can safely stop at the stop position detected from the captured image.

### <Expression 4>

The vehicle 1A according to any one of Expressions 1 to 3 may start when the traffic light information 200 received while the vehicle 1A is stopped before the stop position indicates traveling permission.

Accordingly, the vehicle 1A can autonomously start when the received traffic light information 200 is changed from the stop command to the traveling permission.

### <Expression 5>

In the vehicle 1A according to Expression 4, the traveling permission of the traffic light information 200 may correspond to blue lighting or green lighting of the traffic light 6. Accordingly, the vehicle 1A can autonomously start when the traffic light 6 is changed from red lighting to the blue lighting (or green lighting).

### <Expression 6>

The vehicle 1A according to any one of Expressions 1 to 5 may further include an output circuit (for example, the HMI device 20) configured to output the traffic light information 200.

Accordingly, the vehicle 1A can cause a driver to recognize the content of the traffic light information 200

### <Expression 7>

In the vehicle 1A according to Expression 6, the traffic light information 200 indicating the stop command may further include duration of the stop command, and the output circuit may output the duration of the stop command while the vehicle 1A is stopped before the stop position.

Accordingly, the vehicle 1A can cause the driver to recognize the duration of the stop command (for example, red lighting).

### <Expression 8>

In the vehicle 1A according to Expression 6, the traffic light information 200 indicating traveling permission may further include duration of the traveling permission, and the output circuit may output the duration of the traveling permission.

Accordingly, the vehicle 1A can cause the driver to recognize the duration of the traveling permission (for example, the duration of blue lighting or green lighting 0.

### <Expression 9>

In the vehicle 1A according to Expression 6 or 7, the traffic light information 200 may include traveling direction information that permits at least one of a right turn, a left turn, and straight ahead, and the output circuit may output the traveling direction information.

Accordingly, the vehicle 1A can cause the driver to recognize the content of the traveling direction information.

### <Expression 10>

In the vehicle 1A according to Expression 9, the traffic light information 200 including the traveling direction information may further include duration of the traveling direction information, and the output circuit may output the duration of the traveling direction information.

Accordingly, the vehicle 1A can cause the driver to recognize the duration in the traveling direction.

### <Expression 11>

The vehicle 1A according to any one of Expressions 1 to 9 may determine whether a speed of the vehicle 1A is less than a predetermined threshold when the received traffic light information 200 indicates a stop request, and may detect a stop position based on a captured image by the imaging device, and stops at the stop position when the speed of the vehicle 1A is less than the predetermined threshold.

Accordingly, when the received traffic light information 200 indicates the stop request, the vehicle 1A can safely stop at the stop position detected from the captured image if the speed is a speed at which the vehicle 1A can safely stop.

### <Expression 12>

In the vehicle 1A according to Expression 11, the stop request of the traffic light information 200 may correspond to yellow lighting of the traffic light 6.

Accordingly, in a case where the traffic light 6 is turned on in yellow, the vehicle 1A can safely stop at the stop position if the speed is a speed at which the vehicle 1A can safely stop.

### <Expression 13>

The vehicle 1A according to Expression 11 or 12 may continue to travel when the speed of the vehicle 1A is equal to or higher than a predetermined threshold.

Accordingly, the vehicle 1A can pass through the intersection without stopping at a position beyond the stop position.

### <Expression 14>

The control device 100 to be mounted on the vehicle 1A, the vehicle 1A including the first wheel 2A and the second wheel 2B, being movable in a predetermined direction using the first wheel 2A and the second wheel 2B, and including an imaging device (for example, the camera device 12) and the wireless communication circuit 18 set to receive the traffic light information 200 which is information related to the traffic light 6 detects a stop position (for example, the stop line 112) based on a captured image (for example, the front image 110) by the imaging device and causes the vehicle 1A to stop at the stop position when the traffic light information 200 received by the wireless communication circuit 18 indicates a stop command.

Accordingly, when the received traffic light information 200 indicates the stop command, the control device 100 can safely stop the vehicle 1A at the stop position detected from the captured image.

### <Expression 15>

When the received traffic light information 200 indicates the stop command, the control device 100 according to Expression 14 may detect a traveling lane and a stop position based on the captured image by the imaging device, and cause the vehicle 1A to stop at the stop position in the traveling lane.

Accordingly, when the received traffic light information 200 indicates the stop command, the control device 100 can cause the vehicle 1A to safely stop at the stop position in the traveling lane detected from the captured image.

### <Expression 16>

In the control device 100 according to Expression 14 or 15, the stop command of the traffic light information 200 may correspond to red lighting of the traffic light 6.

Accordingly, when the traffic light 6 is turned on in red, the control device 100 can cause the vehicle 1A to safely stop at the stop position detected from the captured image.

### <Expression 17>

The control device 100 according to any one of Expressions 14 to 16 may cause the vehicle 1A to start when the traffic light information received while the vehicle 1A is stopped at the stop position indicates traveling permission.

Accordingly, when the received traffic light information 200 is changed from the stop command to the traveling permission, the control device 100 can autonomously start the vehicle 1A.

### <Expression 18>

In the control device 100 according to Expression 17, the traveling permission of the traffic light information 200 may correspond to blue lighting or green lighting of the traffic light 6.

Accordingly, when the traffic light 6 is changed from red lighting to the blue lighting (or the green lighting), the control device 100 can autonomously start the vehicle 1A.

### <Expression 19>

The control device 100 according to any one of Expressions 14 to 18 may output the traffic light information 200 to an output circuit (for example, the HMI device 20) mounted on the vehicle 1A.

Accordingly, the control device 100 can cause the driver to recognize the content of the traffic light information 200.

### <Expression 20>

In the control device 100 according to Expression 19, the traffic light information 200 indicating the stop command may further include duration of the stop command, and the control device 100 may output, to the output circuit, the duration of the stop command while the vehicle 1A is stopped at the stop position.

Accordingly, the control device 100 can cause the driver to recognize the duration of the stop command (for example, red lighting).

### <Expression 21>

In the control device 100 according to Expression 19, the traffic light information 200 indicating the traveling permission may further include duration of the traveling permission, and the control device 100 may output the duration of the traveling permission to the output circuit.

Accordingly, the control device 100 can cause the driver to recognize the duration of the traveling permission (for example, the duration of blue lighting or green lighting 0.

### <Expression 22>

In the control device 100 according to Expression 19 or 20, the traffic light information 200 may include traveling direction information that permits at least one of a right turn, a left turn, and straight ahead, and the control device 100 may output the traveling direction information to the output circuit.

Accordingly, the control device 100 can cause the driver to recognize the content of the traveling direction information.

### <Expression 23>

In the control device 100 according to Expression 22, the traffic light information 200 including the traveling direction information may further include duration of the traveling direction information and the control device may output the duration of the traveling direction information to the output circuit.

Accordingly, the control device 100 can cause the driver to recognize the duration of the traveling direction.

### <Expression 24>

When the received traffic light information 200 indicates a stop request, the control device 100 according to any one of Expressions 14 to 22 may determine whether a speed of the vehicle 1A is less than a predetermined threshold, and when the speed of the vehicle 1A is less than the predetermined threshold, the control device 100 may detect a stop position based on a captured image by the imaging device and cause the vehicle 1A to stop at the stop position.

Accordingly, when the received traffic light information 200 indicates the stop request, the control device 100 can safely stop the vehicle 1A at the stop position detected from the captured image if the speed is a speed at which the vehicle 1A can safely stop.

### <Expression 25>

In the control device 100 according to Expression 24, the stop request of the traffic light information 200 may correspond to yellow lighting of the traffic light 6.

Accordingly, when the traffic light 6 is yellow light, the control device 100 can safely stop the vehicle 1A before the stop position if the speed is a speed at which the vehicle 1A can safely stop.

### <Expression 26>

In the control device 100 according to Expression 24 or 25, the control device 100 causes the vehicle 1A to continue to travel when the speed of the vehicle 1A is equal to or higher than the predetermined threshold.

Accordingly, the control device 100 can cause the vehicle 1A to pass through the intersection without stopping the vehicle 1A beyond the stop position.

Although the embodiments have been described above with reference to the accompanying drawings, the present disclosure is not limited to such an example. It is apparent to a person skilled in the art that various modifications, corrections, substitutions, additions, deletions, and equivalents can be conceived within the scope described in the claims, and it is understood that such modifications, corrections, substitutions, additions, deletions, and equivalents also fall within the technical scope of the present disclosure. In addition, constituent elements in the embodiments described above may be freely combined without departing from the gist of the invention.

### INDUSTRIAL APPLICABILITY

The technique of the present disclosure is useful for achieving safer traveling of a vehicle.

What is claimed is:

1. A vehicle comprising:
a first wheel;
a second wheel, the vehicle being movable in a predetermined direction using the first wheel and the second wheel;
an imaging device; and
a wireless communication circuit set to receive traffic light information which is information related to a traffic light,
wherein, when the received traffic light information indicates a stop command, a stop position is detected based on a captured image by the imaging device, and the vehicle stops at the stop position.

2. The vehicle according to claim 1,
wherein, when the received traffic light information indicates the stop command, the vehicle detects a traveling lane and the stop position based on the captured image by the imaging device, and stops at the stop position in the traveling lane.

3. The vehicle according to claim 1,
wherein the stop command of the traffic light information corresponds to red lighting of the traffic light.

4. The vehicle according to claim 1,
wherein the vehicle starts when the traffic light information received while the vehicle is stopped at the stop position indicates traveling permission.

5. The vehicle according to claim 4,
wherein the traveling permission of the traffic light information corresponds to blue lighting or green lighting of the traffic light.

6. The vehicle according to claim 1, further comprising:
an output circuit configured to output the traffic light information.

7. The vehicle according to claim 6,
wherein the traffic light information indicating the stop command further includes duration of the stop command, and
wherein the output circuit outputs the duration of the stop command while the vehicle is stopped at the stop position.

8. The vehicle according to claim 6,
wherein the traffic light information indicating traveling permission further includes duration of the traveling permission, and
wherein the output circuit outputs the duration of the traveling permission.

9. The vehicle according to claim 6,
wherein the traffic light information includes traveling direction information that permits at least one of a right turn, a left turn, and straight ahead, and
wherein the output circuit outputs the traveling direction information.

10. The vehicle according to claim 9,
wherein the traffic light information including the traveling direction information further includes duration of the traveling direction information, and
wherein the output circuit outputs the duration of the traveling direction information.

11. The vehicle according to claim 1,
wherein, when the received traffic light information indicates a stop request, it is determined whether a speed of the vehicle is less than a predetermined threshold, and when the speed of the vehicle is less than the predetermined threshold, a stop position is detected based on a captured image by the imaging device, and the vehicle stops at the stop position.

12. The vehicle according to claim 11,
wherein the stop request of the traffic light information corresponds to yellow lighting of the traffic light.

13. The vehicle according to claim 11,
wherein the vehicle continues to travel when a speed of the vehicle is equal to or higher than the predetermined threshold.

14. A control device to be mounted on a vehicle, the vehicle including a first wheel and a second wheel, being movable in a predetermined direction using the first wheel and the second wheel, and including an imaging device and a wireless communication circuit set to receive traffic light information which is information related to a traffic light,
wherein, when the traffic light information received by the wireless communication circuit indicates a stop command, the control device detects a stop position based on a captured image by the imaging device and causes the vehicle to stop at the stop position.

15. The control device according to claim 14,
wherein, when the received traffic light information indicates the stop command, the control device detects a traveling lane and the stop position based on the captured image by the imaging device, and causes the vehicle to stop at the stop position in the traveling lane.

16. The control device according to claim 14,
wherein the stop command of the traffic light information corresponds to red lighting of the traffic light.

17. The control device according to claim 14,
wherein the control device causes the vehicle to start when the traffic light information received while the vehicle is stopped at the stop position indicates traveling permission.

18. The control device according to claim 17,
wherein the traveling permission of the traffic light information corresponds to blue lighting or green lighting of the traffic light.

19. The control device according to claim 14,
wherein the control device outputs the traffic light information to an output circuit mounted on the vehicle.

20. The control device according to claim 19,
wherein the traffic light information indicating the stop command further includes duration of the stop command, and
the control device outputs, to the output circuit, the duration of the stop command while the vehicle is stopped at the stop position.
